(19) United States
(12) Patent Application Publication
(10) Pub. No.: US 2026/0093456 A1
(43) Pub. Date: Apr. 2, 2026

(54) QUANTUM RANDOM NUMBER GENERATION USING BOSON SAMPLING BASED ARCHITECTURES

(71) Applicant: ANAMETRIC, INC., Austin, TX (US)

(72) Inventors: Joshua W. Ange, Carrollton, TX (US); Mitchell A. Thornton, Dallas, TX (US); William V. Oxford, Austin, TX (US)

(21) Appl. No.: 19/344,119

(22) Filed: Sep. 29, 2025

Related U.S. Application Data
(60) Provisional application No. 63/701,437, filed on Sep. 30, 2024.

(51) Int. Cl. G06F 7/58

(52) U.S. Cl. CPC G06F 7/588

(57) ABSTRACT

Embodiments of systems and methods for a multi-source true random number generator (TRNG) are disclosed. Specifically, a Quantum Random Number Generators (QRNG) employing a boson sampling based architecture is disclosed. The boson sampling based architecture may include a set of photonic components configured according to parameters optimized to achieve a desired distribution of values.

### RELATED APPLICATIONS

This application claims a benefit of priority under 35 U.S.C. § 119 to U.S. Provisional Patent Application No. 63/701,437 filed Sep. 30, 2024, entitled “Quantum Random Number Generation Using Boson Sampling Based Architectures”, which is hereby fully incorporated by reference in their entirety.

### TECHNICAL FIELD

This disclosure relates generally to quantum computing. In particular, this disclosure relates to embodiments of systems and methods for quantum generation of random numbers. Even more specifically, this disclosure relates to systems and methods for random number generation using boson sampling.

### BACKGROUND

Many computing devices require a continuous supply of random values for various reasons, including to support the implementation of various modern cryptographic methods. The lack of such high-quality random number sources in otherwise secure computing systems has been the cause of several well-documented security breaches. Moreover, it is desirable for the generation of these random bit streams to be accomplished at high data rates to support applications such as modern secure high-speed communications. This need is coupled with the added constraint that random values must be of very high quality in terms of their independence and other statistical properties in order to preserve the integrity of, for example, encryption protocols or other computing operations based on such random numbers. Additionally, high-speed and high-quality random number generators should be as inexpensive, rugged, and reliable as possible when the hosting devices are intended to be mass-produced.

Accordingly, there is a need for systems and methods for relatively inexpensive high-speed and high-quality random number generators.

### SUMMARY

As discussed the quality of the random values produced by such TRNGs are quite important in modern computing. Recently, much work has been done with TRNGs utilizing quantum mechanical phenomena as sources of randomness to generate numbers according to some distribution without any underlying deterministic component. Such Quantum-effect-based TRNGs are referred to as quantum random number generators (QRNGs).

The specific method of generating randomness in a QRNG depends on the type of quantum system used, with a key distinction between discrete-variable (DV) and continuous-variable (CV) approaches. In DV QRNGs, randomness comes from measurements on quantum systems with a finite set of possible outcomes—such as the polarization of a single photon or the spin state of an electron. These systems produce inherently binary or multi-valued outcomes, depending on how many quantum bits (qubits) are involved.

Such DV QRNGs may suffer from certain limitations. Namely, the number of bins that may be utilized is fundamentally constrained by the number of qubits available for ultimate measurement. This bounded outcome space means that increasing the resolution or entropy per sample requires scaling up the system itself, which can be both technically difficult and resource intensive. This limitation introduces several practical problems.

In contrast, CV QRNGs rely on measurements of observables that are substantially continuous in nature. These measurements may capture quantum fluctuations to yield an effective infinite number of potential output states-within the measurement error-resulting in the potential for a correspondingly larger number of potential entropy values (also referred to as output bins). Accordingly, the entropy available per measurement may be significantly higher, and the system can be operated at much higher speeds with less stringent hardware demands.

Thus, embodiments may employ higher-dimensioned qudit-based architectures and continuous-variable qumodes that may be more effective for generating distributions (e.g., of random values) without requiring an exorbitant number of quantum information units. Thus, discrete qudit-based architectures are disclosed, along with a continuous-variable approach to QRNGs.

Specifically, embodiments may implement photonic architectures that not only provide a scalable and feasible alternative to qubit-based QRNGs, but may also mitigate common noise sources. Embodiments may leverage continuous variable quantum computing and Photon-Number Resolving (PNR) detection to implement an photonic architecture for QRNGs that generate high-quality random numbers, even in the presence of such hardware noise like photon loss and crosstalk between modes.

In particular, embodiments may use boson sampling based architectures to generate random numbers, and optimize for the transformation to a uniform (or other, such as binomial or Gaussian) distribution. Boson sampling may involve the evolution of photons through a linear network described by a unitary matrix, which is implemented from beam splitter and phase shifter components. These gates mix the input modes coherently and redistribute the photons across the output modes with a probability that is, in general, difficult to compute, as it involves the permanents of submatrices of the unitary transformation.

Embodiments as described herein may utilize the diffuse output probability of boson sampling and extract the maximum possible information for randomness. Importantly, such embodiments may be utilized and function at room temperature. Additionally, as opposed to DV qubit-based architectures, embodiments may show that sources of noise like photon loss are not prohibitive with respect to random number generation (and in some cases, higher levels of photon loss may actually increase the resemblance to a uniform, or other desired type of, distribution of the output of embodiments).

In one embodiment, a system for a quantum true random number generator, comprises a source of randomness comprising one or more photon sources serving as qumodes, a boson sampling photonic circuit coupled to each of the qumodes, and an extractor adapted to extract a set of random values from the source of randomness, wherein the set of random values are an output of the quantum true random number generator.

In some embodiments, the set of random values conform to a distribution such as a uniform distribution, a Gaussian distribution or a binomial distribution.

In certain embodiments, the boson sampling photonic circuit comprises a set of components, each of the components configured according to a corresponding parameter adapted to achieve the intended distribution. For example, the set of components may comprise at least one rotator and at least one beamsplitter, wherein the corresponding parameter for each rotator comprises a number of radians of rotation and the corresponding parameter for each beamsplitter comprises a splitting ratio.

In one particular embodiment, the boson sampling photonic circuit comprises a first waveguide coupled to a first qumode, a second waveguide coupled to a second qumode, and a third waveguide coupled to a third qumode. The first waveguide is coupled to a first rotator, an output of the first rotator is coupled to a first beamsplitter, a first output of the first beamsplitter is coupled to a second rotator, an output of the second rotator is coupled to a second beamsplitter, a first output of the second beamsplitter is coupled to a third rotator, and an output of the third rotator coupled to a first photodetector.

The second waveguide is coupled to the first beamsplitter, a second output of the first beamsplitter is coupled to a fourth rotator, an output of the fourth rotator is coupled to a third beamsplitter, a first output of the third beamsplitter is coupled to a fifth rotator, an output of the fifth rotator is coupled to the second beamsplitter, and a second output of the second beamsplitter is coupled to a second photodetector.

The third waveguide is coupled to a sixth rotator, an output of the sixth rotator is coupled to the third beamsplitter, and a second output of the third beamsplitter is coupled to a third photodetector.

In an embodiment, corresponding parameters for each of the set of components was determined by an optimization. Such an optimization can be associated with a number of bins of the extracted set of random values. This optimization may be performed, for example, using Nelder-Meade optimization. Markov Chain Monte Carlo (MCMC) optimization. or Newton-Raphson optimization.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a block diagram of an architecture for a quantum entropy based random number generator.

FIG. 2 is a block diagram of an architecture for a boson sampling architecture.

FIG. 3 is a flow diagram depicting a method for a QRNG.

FIG. 4 is a table for use in generating a radix-(N+1)² number.

FIG. 5 is an example of an expression of a unitary matrix.

FIG. 6 is an example of results of utilizing an optimization.

FIGS. 7A, 7B, 8A, and 8B depict examples of raw and transformed outputs.

FIGS. 9A and 9B are example results associated with modeled photon loss.

FIGS. 10A and 10B are example results associated with modeled entanglement strength or crosstalk.

### DETAILED DESCRIPTION

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions or rearrangements within the spirit or scope of the underlying inventive concept will become apparent to those skilled in the art from this disclosure.

Before describing embodiments in more detail some additional context may be useful. Many computing devices require a continuous supply of random values to support the implementation of various modern cryptographic methods or for other reasons. The lack of such high-quality random number sources in otherwise secure computing systems has been the cause of several well-documented security breaches. Moreover, it is desirable for the generation of these random bit streams to be accomplished at high data rates to support applications such as modern secure high-speed communications. This need is coupled with the added constraint that random values must be of very high quality in terms of their independence and other statistical properties in order to preserve the integrity of, for example, encryption protocols or other computing operations based on such random numbers. Additionally, it is desired that high-speed and high-quality random number generators should be as inexpensive, rugged, and reliable as possible when the hosting devices are intended to be mass-produced.

Accordingly, there is a need for systems and methods for such relatively inexpensive high-speed and high-quality random number generators (RNGs). Classical schemes for RNGs include pseudorandom number generators (PRNGs) that deterministically generate a seemingly random sequence of numbers from an initial seed. For true random number generators (TRNGs), a “weakly random source” of entropy is employed that makes use of a source of randomness that arises in nature.

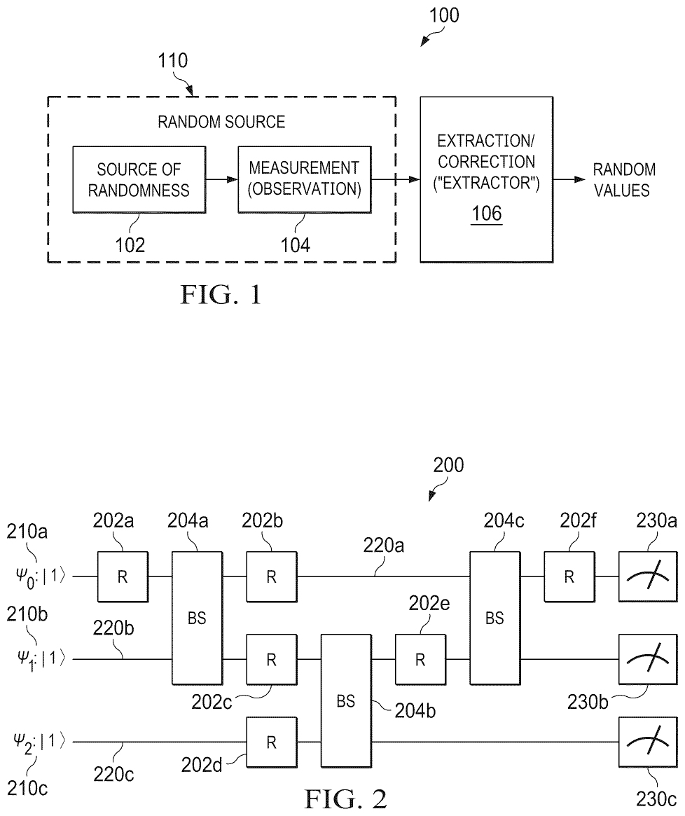

To elaborate further, FIG. 1 depicts an architecture for a random number generator (RNG) 100 (sometimes referred to as a True RNG or TRNG). TRNG 100 includes a randomness source 110 including physical source of randomness 102 and an observation or measurement stage 104. TRNG may also include a post-measurement processing stage 106 known as an “extractor” function. The physical source 102 produces a source of randomness, the measurement stage 104 observes the source of randomness 102 and provides the observations to the extractor function 106 that transforms the measured output of the physical source 102 into random values that can be output and used for a variety of purposes.

Many different “weakly” random sources 102 have been identified and may be used in TRNG 100, such as those based upon quantum effects, electronic metastability, electronic chaos generation, radioactivity, thermal effects, atmospheric effects, deep space radiators, and others. Because the theory of observing the results of quantum mechanical interactions is based on probabilistic axioms, sources of randomness 102 that rely upon the measurement or observation of states of particles may be used as sources in RNG 100.

One of the reasons that randomness source 110 (e.g., including observation or measurement stage 104) used in RNGs 100 are sometimes referred to as a “weakly random source” is that it is practically impossible to measure or observe the output of physical source 102 without adding some degree of determinism, bias, or correlation. For this reason, TRNG 100 u incorporates extractor functions 106, or simply “extractors,” that transform the output of a weakly random source into an) an independent string of random bits of a desired distribution that can be output as the random values of the RNG 100. This distribution can be equally likely (i.e., a uniform probability distribution), a Gaussian distribution, a binomial distribution, etc.

More specifically, the purpose of the extractor 106 may be to discard undesired biases, correlations, or other deterministic components in the source measurements provided by measurement stage 104 and to transform random values to output values that are as close as possible to being independent and that are distributed as desired. From an information theoretic point of view, the goal of the extractor 106 is to maximize the information entropy in the output values by utilizing as much of the entropy present in the physical source 102 as possible. Furthermore, the extractor function 106 ideally produces values that are independent and distributed according to a desired distribution regardless of the native distribution of the physical source observations produced by measurement stage 104. For at least these reasons, extraction functions 106 are very important with regard to the quality of RNG 100 output values.

While TRNG 100 may operate using a single source of entropy, in many cases the quality of the random values produced by a TRNG 100 may be improved by using two or more sources of entropy. However, these multiple sources are usually separate and independent (i.e., uncorrelated). It will be noted here that the concept of a single source of entropy may be considered as different than a single physical source of entropy. In many cases, multiple sources of entropy may be derived from a single physical source of entropy.

As discussed the quality of the random values produced by such TRNGs are quite important in modern computing. om number generators. To illustrate in more detail, TRNGs are critical for problems involving security and cryptography. Thus, a natural choice for this phenomena is that which is quantum in nature, leading to the notion of quantum random number generators (QRNGs). Accordingly, much work has been done with TRNGs utilizing quantum mechanical phenomena as sources of randomness to generate numbers according to some distribution without any underlying deterministic component.

While qubit-based quantum computers can serve as high-quality sources of randomness, their effectiveness is limited by the number of qubits necessary for fine-grained distributions (e.g., the number of measurement outcomes or bins scales as 2\hat{ }n with qubits n). In contrast, photonic quantum computers offer promising scalability, both from their experimental realization at room temperatures and from the use of linear optical components and photon number resolving detectors to generate varied distributions.

A central concept in realizing QRNGs is to exploit the superposition of a qubit |ψ [symbol] that is in equal superposition between two states |0 [symbol] and |1 [symbol] such that

$$\vert ψ 〉 = \frac{1}{\sqrt{2}} \vert 0 〉 + \frac{1}{\sqrt{2}} \vert 1 〉 .$$

By measuring the qubit with respect to the computational basis, one has an equal probability of observing either state. This measurement thus serves as a TRNG that effectively performs a Bernoulli trial with an equal likelihood of success/failure. Practical difficulties arise in implementations that exploit this fundamental idea due to hardware biases and other noise sources that can pollute the desired distribution and affect the number of possible outputs per qubit.

The specific method of generating randomness depends on the type of quantum system used, with a key distinction between discrete-variable (DV) and continuous-variable (CV) approaches. In DV QRNGs, randomness comes from measurements on quantum systems with a finite set of possible outcomes—such as the polarization of a single photon or the spin state of an electron. These systems produce inherently binary or multi-valued outcomes, depending on how many quantum bits (qubits) are involved. Such DV QRNGs may suffer from certain limitations. Namely, as discussed, the number of bins is fundamentally constrained by the number of input qubits. This bounded outcome space means that increasing the resolution or entropy per sample requires scaling up the system itself, which is both technically difficult and resource intensive.

This limitation introduces several practical problems. First, because the bin size is fixed and relatively small, DV QRNGs extract only a limited amount of entropy per measurement event. This restricts their efficiency and the rate at which high-quality randomness can be generated. Second, the finite number of outcomes makes DV systems more susceptible to statistical bias, especially when hardware imperfections or detector inefficiencies skew the probabilities away from uniformity.

In contrast, CV QRNGs rely on measurements of observables which are substantially continuous in nature. These measurements may capture quantum fluctuations to yield a greater number of bins. Accordingly, the entropy available per measurement may be significantly higher, and the system can be operated at much higher speeds with less stringent hardware demands. In particular, continuous variable photonic quantum computers (e.g., general purpose photonic computers or Quantum Photonic Integrated Circuit (QPIC)) offer promising scalability for use in QRNGs both from their experimental realization and from the use of linear optical components and photon number resolving detectors to generate varied distributions.

Continuous-variable quantum computing is a paradigm distinct from discrete-variable qubit-based computing. Rather than being expressed in terms of a discrete basis, a continuous-variable qumode
   |ø [symbol] =∫dxØ(x)|x [symbol] is used, where the |x [symbol] states are eigenstates of the

$$\hat{x} = \sqrt{\frac{ℏ}{2}} ( \hat{a} = {\hat{a}}^{†} )$$

quadrature (where â is the typical annihilation operator). Equivalently, they can also be expressed in terms of the momentum quadrature

$$\hat{p} = - {i}^{▲} \sqrt{\frac{ℏ}{2}} ( \hat{a} - {\hat{a}}^{†} )$$

As implied by the form of these quadratures involving annihilation and creation operators, the CV formulation of quantum phenomena is a particularly useful representation for photonic quantum computing systems. CV computation may thus be beneficial for practical TRNG development due to room-temperature realizations and a continuum of outputs that potentially enable higher-resolution final distributions (for example, compared to the output of two possible states per qubit). Many photonic quantum computers (e.g., Xanadu's X8 photonic quantum computer) may be supports qumode-based computing and QPICs may also be implemented to utilize such qumode-based computing.

Thus, embodiments may employ higher-dimensioned qudit-based architectures and continuous-variable qumodes that may be more effective for generating distributions without requiring an exorbitant number of quantum information units. Thus, discrete qudit-based architectures are disclosed, along with a continuous-variable approach to QRNGs.

Specifically, embodiments may implement photonic architectures that not only provide a scalable and feasible alternative to qubit-based QRNGs, but may also mitigate common noise sources. Embodiments may leverage continuous variable quantum computing and Photon-Number Resolving (PNR) detection to implement an photonic architecture for QRNGs that generate high-quality random numbers, even in the presence of such hardware noise like photon loss and crosstalk between modes.

In particular, embodiments may use boson sampling based architectures to generate random numbers from hard to predict diffuse distributions, and optimize for the transformation to a uniform (or other, such as binomial or Gaussian) distribution. Boson sampling is considered a powerful example of an “intermediate quantum computer,” designed to implement a computation that is intractable classically. In particular, boson sampling involves the evolution of single photons through a linear network described by a single unitary matrix, which is implemented (e.g., solely) from beam splitter and phase shifter components. These gates mix the input modes coherently and redistribute the photons across the output modes with a probability that is, in general, difficult to compute, as it involves the permanents of submatrices of the unitary transformation.

In addition to the straightforward production of equally distributed true random numbers, embodiments may also use this same architecture to produce non-uniform-distributions of entropy; such as binomial or sampled-gaussian entropy, which is highly useful for many applications, including Learning-with-Errors (LWE) and Post-Quantum Cryptography (PQC).

More specifically, boson sampling can act as a high-quality source of entropy. Thus, boson sampling based approaches realized with photonic quantum computers (including QPICs) can be used to generate random numbers in diffuse, hard to predict, distributions, and can be optimized for transformation to a uniform distribution (or other types of distribution desired). Embodiments may thus also apply a strategy for scaling a boson sampling based TRNG (both in terms of the number of qumodes available and improvements for photonic components).

While boson sampling has been proposed as a source of entropy previously, the full utilization of the diffuse output probability distribution is not made (for example, only measuring modes in the Fock basis (number state) as either zero or non-zero, and not considering various mode measurements). Embodiments as described herein may utilize the diffuse output probability of boson sampling and extract the maximum possible information for randomness. Importantly, such embodiments may be utilized and function at room temperature. Additionally, as opposed to DV qubit-based architectures, embodiments may show that sources of noise like photon loss are not prohibitive with respect to random number generation (and in some cases, higher levels of photon loss may actually increase the resemblance to a uniform, or other desired type of, distribution of the output of embodiments).

Turning then to FIG. 2, one embodiment of a photonic circuit implementing a boson sampling architecture for three qumodes is depicted. Such a photonic circuit can be implemented, for example, using a general purpose photonic computer or may be implemented using a QPIC and may server as a source of randomness in a QRNG (e.g., as described with respect to FIG. 1). It will be noted here, that while embodiments of a boson sampling circuit for three qumodes is depicted by way of example, other embodiments may be equally effectively applied and utilized with photonic circuits that utilize more than three qumodes and such embodiments and circuits are fully contemplated herein.

Here, circuit 200 comprise photonic components comprising phase space rotation gates 202 (e.g., referred to as rotation gates or ‘R’) and beamsplitters 204 (referred to as ‘BS’). The parameters for rotation gates 202 (e.g., the radians of rotation which a rotation gate 202 is adapted to implement) and the parameters for each of beamsplitters 204 (e.g., the ratio of beamsplitting adapted to be implemented by a beamsplitter 204) may be optimized to achieve a desired distribution of entropy (e.g., random numbers) as will be discussed.

A first qumode 210a may be provided by a first source of photons (e.g., a laser or the like). This first qumode 210a is coupled (e.g., via a waveguide 220a) to a rotation gate 202a. The output of rotation gate 202a is coupled to beamsplitter 204a via waveguide 220a. The output of beamsplitter 204a on waveguide 220a is coupled to rotation gate 202b. Output of rotation gate 202b on waveguide 220a is coupled to beamsplitter 204c. Output of beamsplitter 204c on waveguide 220a is coupled to rotation gate 202f and the output of rotation gate 202f on waveguide 220a is coupled to a photodetector 230a, which may be a homodyne detector or the like capable of Photon-Number Resolving (PNR) detection allowing photodetector 230a to distinguish the number of photons arriving in a single event (e.g., sampling window). This number of photons is referred to as the Fock state or number state. These events may occur at a sample rate such that a Fock state may thus be produced (or derived from) photodetector 230a at a sample rate.

A second qumode 210b may be provided by a second source of photons (e.g., which may be the same, or different, physical source of photons that provides first qumode 210a). This second qumode 210b is coupled (e.g., via a waveguide 220b) to beamsplitter 204a. The output of beamsplitter 204a on waveguide 220b is coupled to rotation gate 202c. The output of rotation gate 202c on waveguide 220b is coupled to beamsplitter 204b. The output of beamsplitter 204b on waveguide 220b is coupled to rotation gate 202e. The output of rotation gate 202e on waveguide 220b is coupled to beamsplitter 204c and the output of beamsplitter 204c on waveguide 220b is coupled to photodetector 230b (e.g., a homodyne detector that may implement PNR detection). Thus, a Fock state may also be produced (or derived from) photodetector 230b at a sample rate.

A third qumode 210c may be provided by a third source of photons (e.g., which may be the same, or different, physical source of photons that provides first qumode 210a or second qumode 210b). This third qumode 210c is coupled (e.g., via a waveguide 220c) to a rotation gate 202d. The output of rotation gate 202d is coupled to beamsplitter 204b via waveguide 220c. The output of beamsplitter 204b on waveguide 220c is coupled to photodetector 230c (e.g., a homodyne detector that may implement PNR detection). Again, a Fock state may be produced (or derived from) photodetector 230c at a sample rate.

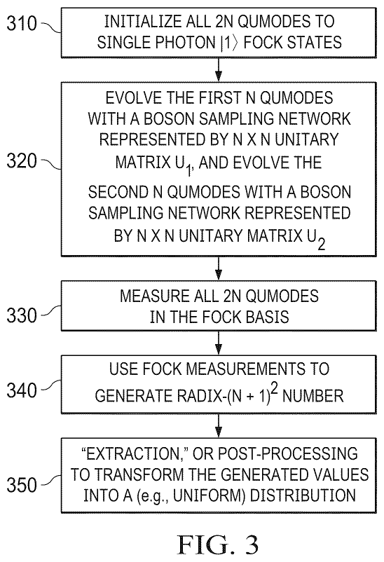

An overall architecture for boson sampling according to embodiments can be equivalently expressed with a unitary matrix. One embodiment of general architecture or method for a QRNG with 2N available qumodes is structured as depicted in FIG. 3. The steps include initializing all 2N qumodes to single photon |1 [symbol] Fock states (STEP 310). The first N qumodes can be evolved with a boson sampling network represented by N×N unitary matrix U1, and the second N qumodes can be evolved with a boson sampling network represented by N×N unitary matrix U2 (STEP 320). All 2N qumodes can be measured in the Fock basis (STEP 330). These Fock measurements can be used to generate radix-(N+1)² number (STEP 340). “Extraction,” or post-processing can be used transform the generated values into a uniform distribution (e.g., of entropy values) (STEP 350).

Embodiments are described herein with respect to the architecture for 2×3=6 qumodes to generate random numbers. Such procedures and embodiments may also be employed utilizing all (e.g., 2×4=8) qumodes of a general computer (e.g., the X8) or additional qumodes when available (e.g., in a QPIC or higher qumode photonic computer). As the number of qumodes increases the optimization of the unitary matrix may, however, become commensurately more difficult.

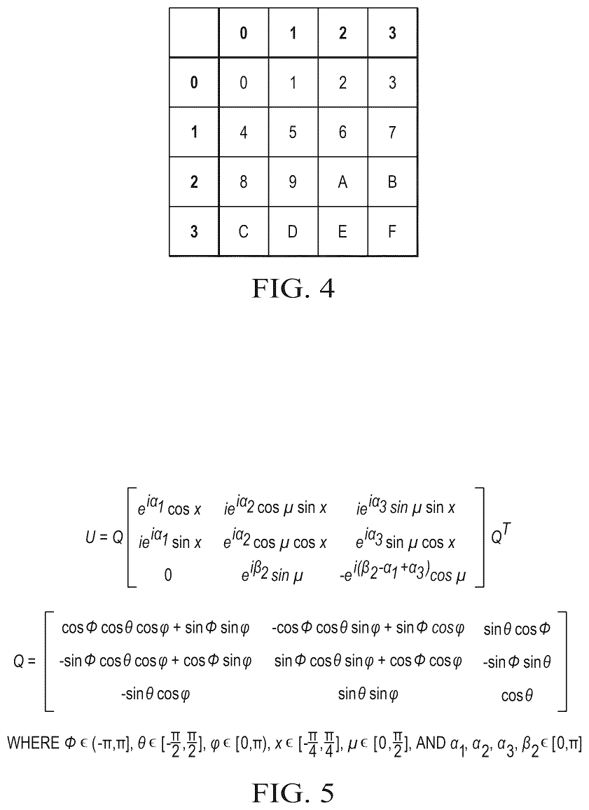

To generate a radix-(N+1)² number in STEP 340, a table such as that in FIG. 4 may be utilized. Given two Fock measurements i and j (one from either set of N qumodes), a radix-(N+1)² digit is generated by selecting the element in the (i+1)th column and (j+1)th row. For example, for N=3, if the measurements from the first N qumodes are 2, 0, 1 and the measurements from the second N qumodes are 3, 0, 0, then the resultant radix-16 number is E01 (or 3585 in the more familiar base-10).

The extraction process in STEP 350 involves taking the cumulative distribution function (CDF) of the radix-(N+1)² number distribution and performing a transformation such that the new distribution approximates a uniform distribution over [0, 1]. This distribution has

$${( \begin{matrix}2 N + 1 \\ N - 1\end{matrix} )}^{2}$$

non-identity points that can be collected into a chosen number of bins for a final distribution. Note that while, in principle, this would lead one to believe that a uniform distribution of bins could be constructed, the conservation of photons means there will invariably be smaller probabilities for numbers at the extremes (e.g., base 16 000 or FFF) so that distribution will never be appropriately uniform. In practice, the difficulty for this procedure comes by optimizing the parameters of the boson sampling architecture for a desired number of output bins.

As mentioned above, one difficulty involved in implementing embodiment of a QRNG using a boson sampling architecture comes in optimizing the parameters of the boson sampling circuit in order to approach a uniform (or other desired) distribution. In the case of six qumodes, embodiments may utilize two 3×3 unitary matrices that each evolve the states of three qumodes with a boson sampling network. Embodiments follow the parameterization where any 3×3 unitary matrix U can be expressed as depicted in FIG. 5. These nine variables shown in FIG. 5 (e.g.,

$$∅ ∈ ( - π , π ) , θ ∈ [ - \frac{π}{2} , \frac{π}{2} ] , φ ∈ [ 0 , π ) , χ ∈ [ - \frac{π}{4} , \frac{π}{4} ] , μ ∈ [ 0 , \frac{π}{2} ] ,$$

and α₁, α₂, α₃, β₂∈[0, π)) are those across which embodiments may minimize the distance between our generated distribution and true uniformity (but in principle could be used to minimize distance to any desired distribution). This parameterization is used as a matter of convenience, but may not actually reduce (nor increase) the number of free parameters corresponding to the boson sampling system (e.g., an embodiment as depicted in FIG. 1). Such parameterization may be applied on greater values of a unitary matrix. For example, a 4×4 matrix, the analogous parameterization would require minimization across at least 16 variables.

When it comes to minimizing the distance between the generated distribution and an ideal uniform distribution, there is no obvious metric. This is especially the case when ‘overbinning,’ as discussed below, where the height of multiple entries in the histogram may be zero and so metrics like mean-squared error (MSE) are not always best to optimize for. Thus, taking p and q to be our generated distribution and that of an ideal uniform output, the 1-Wasserstein distance (WS) may be considered

$$WS ( p \vert \vert q ) = ( \frac{1}{n} {\sum }_{i = 1}^{n} \vert p ( {x}_{i} ) - q ( {x}_{i} ) \vert ) ,$$

the Kullback-Leibler (KL) divergence

$$KL ( p \vert \vert q ) = {\sum }_{i = 1}^{n} p ( {x}_{i} ) log ( \frac{p ( {x}_{i} )}{q ( {x}_{i} )} ) ,$$

and the Jensen-Shannon (JS) divergence

$$JS ( p \vert \vert q ) \sqrt{\frac{KL ( p \vert \vert m ) + KL ( q \vert \vert m )}{2}}$$

(where m is the pointwise mean between p and q) that all intend to measure the similarity between their argument distributions in order to optimize the parameters of the boson sampling network.

Numerous optimization techniques may be utilized to optimize the parameters of the components of a boson sampling circuit. For example, Markov Chain Monte Carlo (MCMC) optimization may be applied. In certain cases, however, MCMC optimization may fail to converge in any tractable timescale, likely due to the high correlation between any individual parameter of the unitary matrix and the final distribution desired. Newton-Raphson optimization may be relatively quick in its optimization and may also be applied. This optimization may, however, fail to achieve desirable uniform distributions in certain cases. Nelder-Meade may be another optimization technique that may be applied according to embodiments.

An important notion for optimizing boson sampling architecture is that of ‘overbinning’ and ‘underbinning.’ Thus, embodiments may optimize first using overbinning or underbinning and then perform a transformation to reach the desired number of bins. For example, given a desired final distribution of 25 bins, one may optimize the boson sampling parameters first to 10 bins (e.g., in STEP 350 as depicted with respect to FIG. 3), and then perform a secondary CDF transformation to the desired 25 bins (‘underbinning’). As another example, optimization may be performed first to 1000 bins, and then a secondary CDF transformation performed to optimize to the desired 25 bins (‘overbinning’). Overbinning may be thought of as useful, as one could, in principle, take an overbinned distribution and then choose a desired distribution at a later date, but such overbinning may actually underperform ‘proper’ binning (i.e., neither overbinning nor underbinning). Where overbinning shows significant utility is with respect to increased hardware noise as will be discussed below.

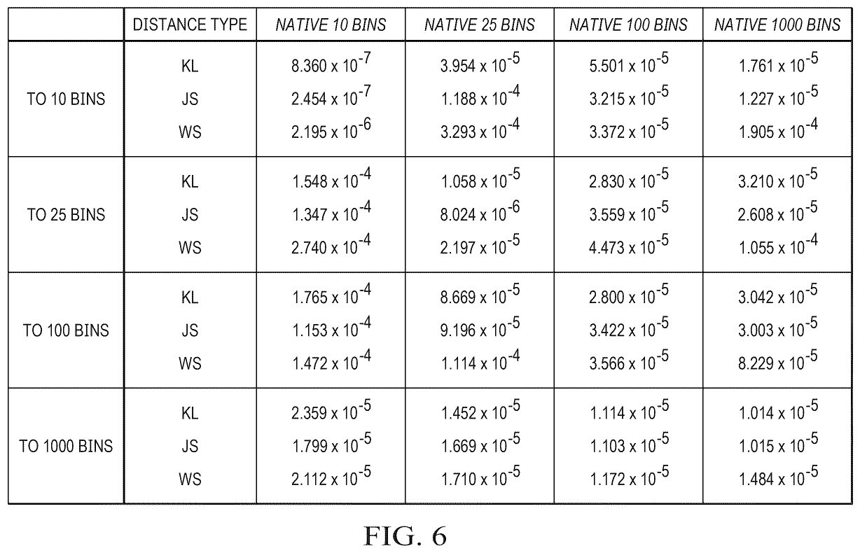

As but one example, the results of utilizing Nelder-Meade optimization are presented in FIG. 6. Because Nelder-Meade optimization is prone to falling into local minima, the optimization procedure was run in this example, 100 times for each of the three distance metrics. The final distance metrics to the uniform distribution can be seen in FIG. 6 where a table of the best MSE of parameter optimization to different distance metrics across Nelder-Meade runs is presented.

In this figure, ‘Native’ bins refers to the number of bins in the distribution that are optimized in STEP 350 of the method presented in FIG. 3 and the bin count on the left hand side of the table in FIG. 6 refers to a secondary transformation. Thus entries along the diagonal of the table are properly binned, those in the upper right half of the table are overbinned, and those in the lower left half of the table are underbinned.

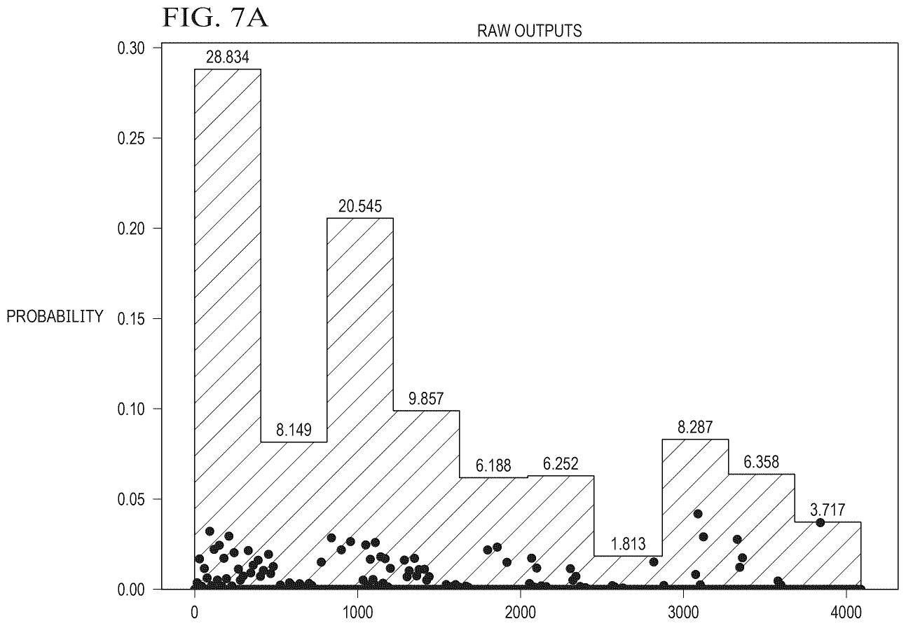

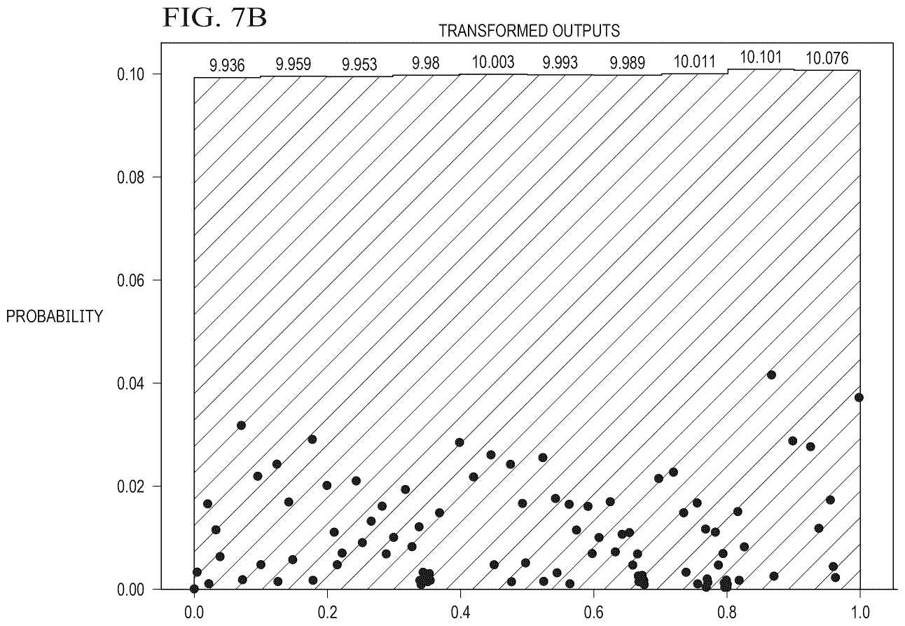

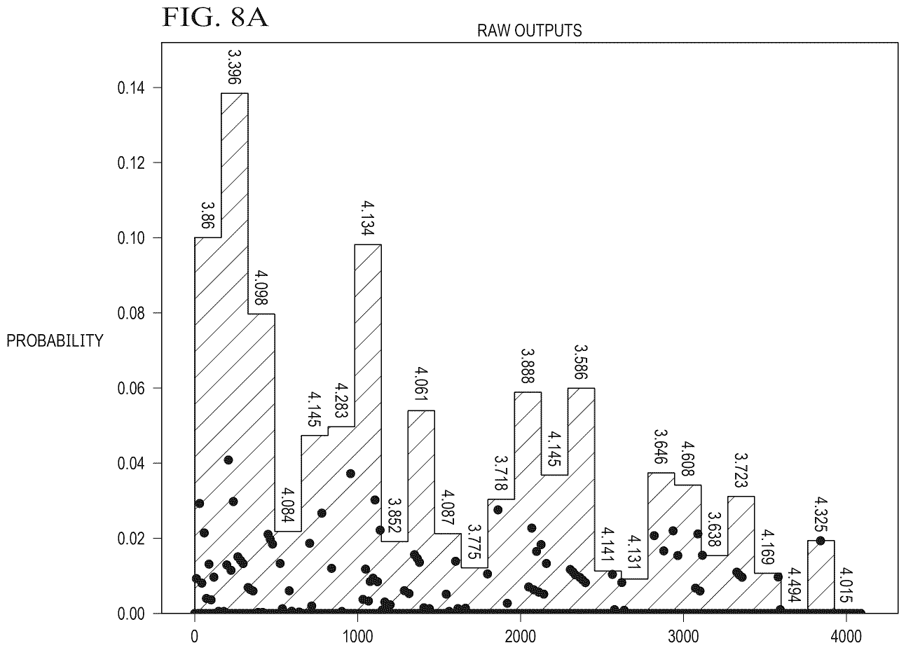

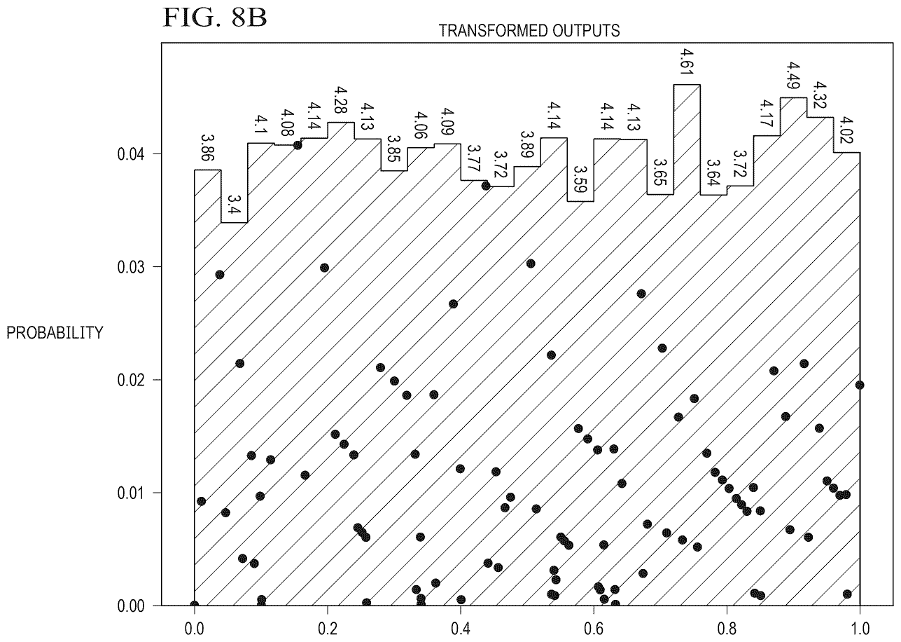

From FIG. 6 it can be seen that, in this case, the best performing metrics for the goal of 10 and 25 uniform bins is the Jensen-Shannon (JS) divergence, with MSE of 2.45×10⁻⁷ and 8.024×10⁻⁶ respectively. FIGS. 7A, and 8A present the raw outputs (e.g., as arising from using Fock measurements to generate radix-(N+1)² number(s) for, respectively, a 10-bin distribution and a 25-bin distribution. Post processed outputs results from performing extraction or post-processing to transform the generated values into a uniform distribution for the 10-bin distribution and the 25-bin distribution are presented in FIGS. 7B and 8B respectively. It may be observed that, in this example, neither overbinning nor underbinning may be useful.

Hardware noise may also be a factor in parameter optimization, thus it may be useful in certain embodiments to account for (e.g., model) such hardware noise. For example, the largest sources of hardware noise for a photonic computer (e.g., like the Xanadu X8) may be photon loss, entanglement strength, or susceptibility to crosstalk between qumodes.

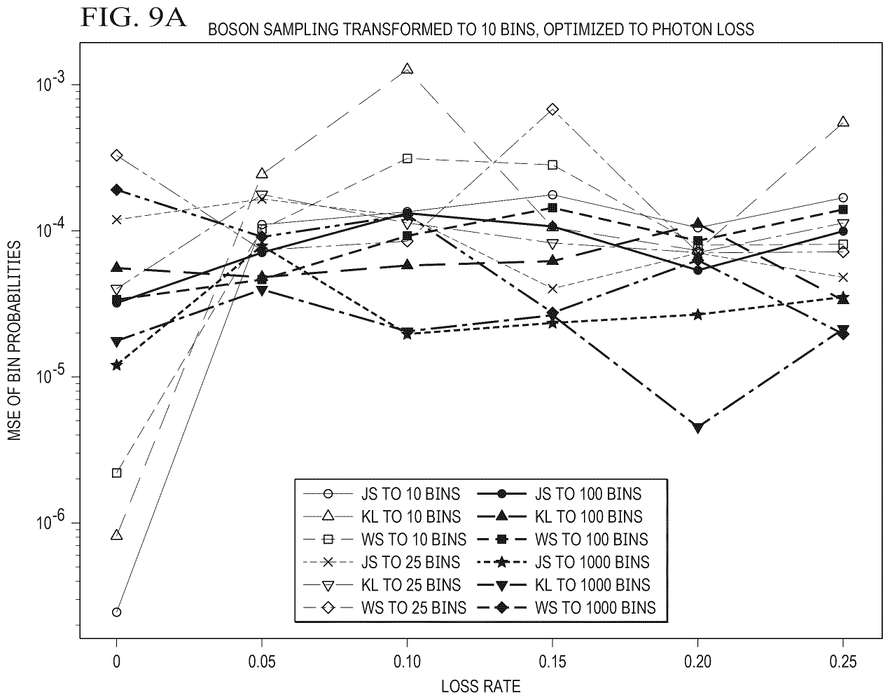

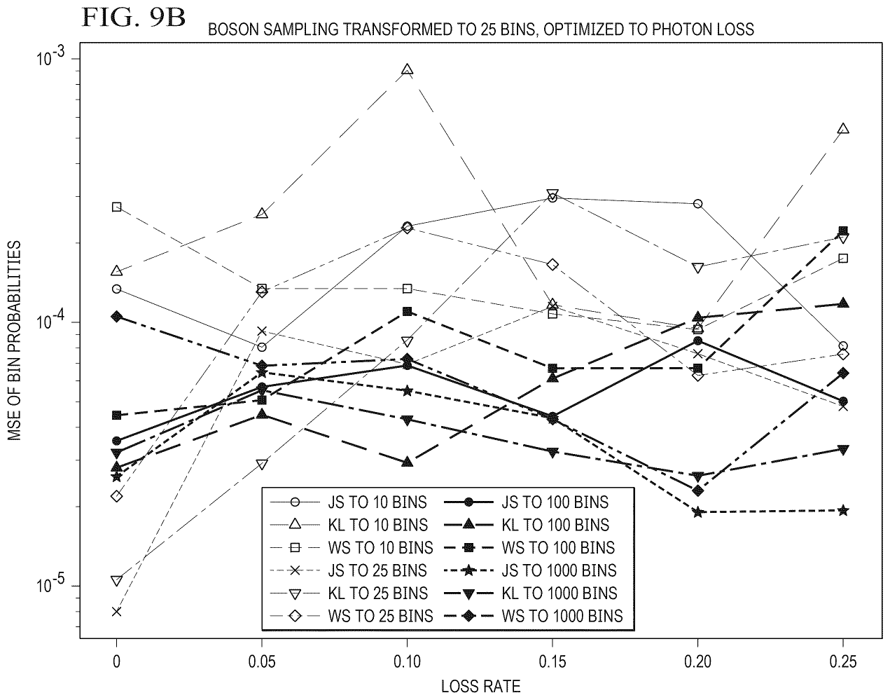

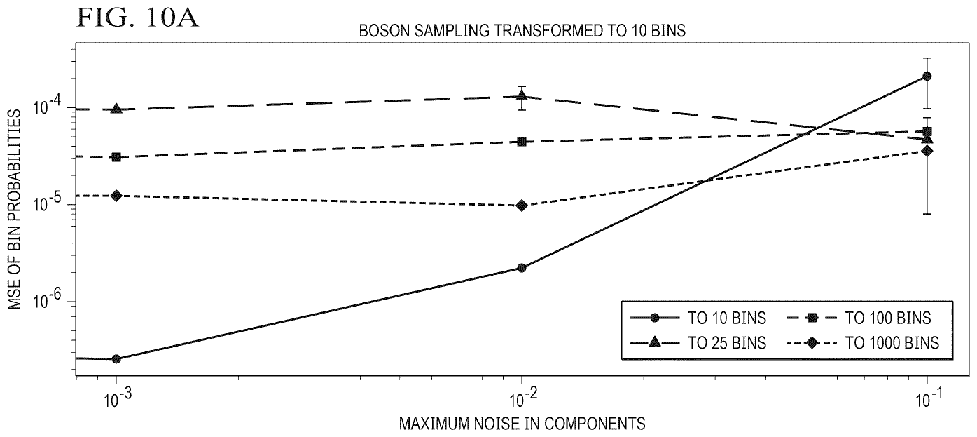

Accordingly, photon loss may be introduced into the circuit prior to parameter optimization to observe how the resemblance to uniformity changes with varying photon loss rates. FIGS. 9A and 9B present results for an embodiment of a QRNG architecture with photon loss as transformed to 10 bins (FIG. 9A) and 25 bins (FIG. 9B) from various native bin counts. As can be seen in FIGS. 9A and 9B, while photon loss may always result in a larger minimum distance between a resultant distribution and uniformity, there is not a strict decrease in performance with increasing rates of photon loss.

In particular, as the loss rate increases, the number of possible radix-(N+1)² number(s) generated increases (because conservation of photon count is not such a strict constraint), and thus in principle allows for more performant parameter values. Additionally, this is where it may be observed that overbinning has a positive effect on the final distributions. This is likely because the increased number of raw outputs are more aptly able to be ‘picked out’ by the finer bin number, and so the final CDF more closely brings us to uniformity. Thus, embodiments of the QRNG architecture as presented herein may, in certain embodiments, may be made increasingly resistant to increasing rates of photon loss by employing overbinning.

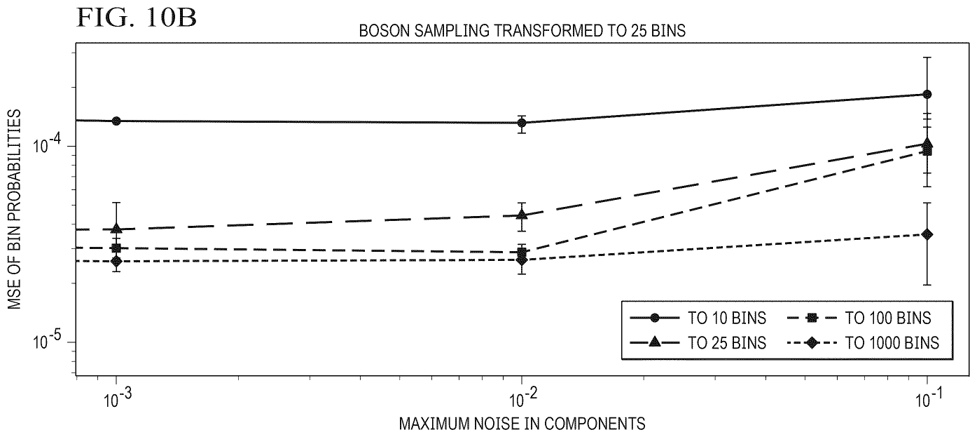

The other main source of hardware noise (e.g., other than photon loss) comes from entanglement strength and crosstalk between qumodes. Because, in embodiments of the disclosed boson sampling architecture, all the qumodes may be interacting with one another, this engagement strength or crosstalk can be modeled as an imprecision in the optimized parameters. In particular, taking the Jensen-Shannon optimized values, varying levels of noise may be introduced in component parameters, and the influence on the final MSE of bin probabilities to a uniform distribution recorded. This can be seen for 10-bins and 25-bins in FIGS. 10A and 10B respectively.

Again, it can be observed that overbinning may be utilized to preserve relatively low MSE when introducing larger noise values in the parameters for photonic components. It should also be noted that this is based on the idea that the CDF used to perform extraction or post processing to transform generated values into a uniform distribution (e.g., STEP 350 of FIG. 3) for the final transformation is built by recording the output of the architecture over time (e.g., rather than being known or determined a priori). This is because rates such as photon loss or crosstalk between components may be difficult to determine in advance. But given a satisfactory amount of time to generate such a CDF, embodiments of the architecture as disclosed may be relatively secure against these sources of hardware noise.

Embodiments have been described with reference to specific embodiments. However, one of ordinary skill in the art appreciates that various modifications and changes can be made without departing from the scope of the invention. Accordingly, this description is to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such an embodiment, feature, or function). Rather, the description is intended to describe illustrative embodiments, features, and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Reference throughout this specification to “one embodiment,” “an embodiment,” or “a specific embodiment,” “a specific implementation,” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Furthermore, the term “or” as used herein is generally intended to mean “and/or” unless otherwise indicated. As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A system for a quantum true random number generator, comprising:
a source of randomness comprising:
one or more photon sources serving as qumodes; and
a boson sampling photonic circuit coupled to each of the qumodes; and
an extractor adapted to extract a set of random values from the source of randomness, wherein the set of random values are an output of the quantum true random number generator.

2. The system of claim 1, wherein the set of random values conform to a distribution.

3. The system of claim 2, wherein the distribution is a uniform distribution.

4. The system of claim 2, wherein the distribution is a Gaussian distribution.

5. The system of claim 2, wherein the distribution is a binomial distribution.

6. The system of claim 2, wherein the boson sampling photonic circuit comprises a set of components, each of the components configured according to a corresponding parameter adapted to achieve the distribution.

7. The system of claim 6, wherein the set of components comprise at least one rotator and at least one beamsplitter, wherein the corresponding parameter for each rotator comprises a number of radians of rotation and the corresponding parameter for each the beamsplitters comprises a splitting ratio.

8. The system of claim 7, wherein the boson sampling photonic circuit comprise a first waveguide coupled to a first qumode, a second waveguide coupled to a second qumode, and a third waveguide coupled to a third qumode, wherein:
the first waveguide is coupled to a first rotator, an output of the first rotator is coupled to a first beamsplitter, a first output of the first beamsplitter is coupled to a second rotator, an output of the second rotator is coupled to a second beamsplitter, a first output of the second beamsplitter is coupled to a third rotator, and an output of the third rotator coupled to a first photodetector;
the second waveguide is coupled to the first beamsplitter, a second output of the first beamsplitter is coupled to a fourth rotator, an output of the fourth rotator is coupled to a third beamsplitter, a first output of the third beamsplitter is coupled to a fifth rotator, an output of the fifth rotator is coupled to the second beamsplitter, and a second output of the second beamsplitter is coupled to a second photodetector; and
the third waveguide is coupled to a sixth rotator, an output of the sixth rotator is coupled to the third beamsplitter, and a second output of the third beamsplitter is coupled to a third photodetector.

9. The system of claim 7, wherein corresponding parameters for each of the set of components was determined by an optimization.

10. The system of claim 9, wherein the optimization is associated with a number of bins of the extracted set of random values.

11. The system of claim 9, wherein the optimization is performed using Nelder-Meade optimization.

12. The system of claim 9, wherein the optimization is performed using Markov Chain Monte Carlo (MCMC) optimization.

13. The system of claim 9, wherein the optimization is performed using Newton-Raphson optimization.

14. A boson sampling photonic circuit, comprising:
a first waveguide coupled to a first qumode;
a second waveguide coupled to a second qumode;
a third waveguide coupled to a third qumode; and
a set of components including one or more rotators and one or more beamsplitters,
wherein each of the set of components is configured according to a corresponding parameter determined by an optimization adapted for a distribution of random values, and wherein:
the first waveguide is coupled to a first rotator, an output of the first rotator is coupled to a first beamsplitter, a first output of the first beamsplitter is coupled to a second rotator, an output of the second rotator is coupled to a second beamsplitter, a first output of the second beamsplitter is coupled to a third rotator, and an output of the third rotator coupled to a first photodetector;
the second waveguide is coupled to the first beamsplitter, a second output of the first beamsplitter is coupled to a fourth rotator, an output of the fourth rotator is coupled to a third beamsplitter, a first output of the third beamsplitter is coupled to a fifth rotator, an output of the fifth rotator is coupled to the second beamsplitter, and a second output of the second beamsplitter is coupled to a second photodetector; and
the third waveguide is coupled to a sixth rotator, an output of the sixth rotator is coupled to the third beamsplitter, and a second output of the third beamsplitter is coupled to a third photodetector.

15. The boson sampling photonic circuit of claim 14, wherein the optimization is associated with a number of bins of the random values.

16. The boson sampling photonic circuit of claim 14, wherein the optimization is performed using Nelder-Meade optimization, Markov Chain Monte Carlo (MCMC) optimization or Newton-Raphson optimization.

17. The boson sampling photonic circuit of claim 14, wherein the distribution is a uniform distribution, a Gaussian distribution, or a binomial distribution.
